(19) United States
(12) Patent Application Publication
(10) Pub. No.: US 2018/0166049 A1
(43) Pub. Date: Jun. 14, 2018

(54) APPARATUS FOR STORING, TRANSPORTING AND DISPENSING GUITAR PICKS AND OTHER SUBSTANTIALLY FLAT OBJECTS

(71) Applicant: Lauren Paige Young, Cincinnati, OH (US)

(72) Inventor: Lauren Paige Young, Cincinnati, OH (US)

(21) Appl. No.: 15/836,103

(22) Filed: Dec. 8, 2017

Related U.S. Application Data
(60) Provisional application No. 62/431,571, filed on Dec. 8, 2016.

(51) Int. Cl. G10D 3/16

(52) U.S. Cl. CPC G10D 3/163

(57) ABSTRACT

Apparatus for storing, transporting and dispensing at least one substantially flat object, the apparatus comprising: a holder comprising a front surface and a back surface; at least one recess formed in the front surface of the holder, the at least one recess comprising a floor and an outer perimeter wall, and the at least one recess being sized to seat the substantially flat object therein; and at least one tab mounted to the holder and extending out over the at least one recess, the at least one tab comprising a rear surface facing the floor of the at least one recess, the at least one tab being configured to hold the substantially flat object in the at least one recess.

### REFERENCE TO PENDING PRIOR PATENT APPLICATION

This patent application claims benefit of pending prior U.S. Provisional Patent Application Ser. No. 62/431,571, filed Dec. 8, 2016 by Lauren Paige Young for NOVEL APPROACH FOR STORING AND DISPENSING GUITAR PICKS AND OTHER REASONABLY FLAT OBJECTS (Attorney's Docket No. YOUNG-3 PROV), which patent application is hereby incorporated herein by reference.

### FIELD OF THE INVENTION

This invention relates to apparatus for storing, transporting and dispensing objects in general, and more particularly to apparatus for storing, transporting and dispensing guitar picks and other substantially flat objects.

### BACKGROUND OF THE INVENTION

Guitar players use many different guitar picks to create a variety of sounds while playing the guitar. Picks are thin, flat objects that come in a variety of shapes, typically egg-shaped or triangular-shaped, and are made of a variety of materials that vary in their thickness and flexibility. Guitar players, from beginner to experienced, face the challenge of carrying these picks and having them ready for playing the guitar, whether they are practicing or performing. Guitar players sometimes change picks to achieve different musical effects, and/or sometimes share or trade picks with other guitar players when they like the particular characteristics of a given pick. Thus it is generally desirable to always have several picks on hand for these purposes. Picks may also be used as a promotional item or as a “business card” when the performer's name or business name is displayed on the pick. For these reasons, it is desirable for guitar players to have an easy way to store, transport and dispense guitar picks so that the guitar picks are readily available for playing the guitar, trading or handing out as promotional items.

Devices have been developed to address the need for storing, transporting and dispensing guitar picks. Some prior art devices focus on guitar pick dispensers that require temporary or permanent attachment to a human, a guitar, a guitar strap, or a guitar case. See, for example, U.S. Pat. Nos. 4,785,708; 4,890,531; 5,127,300; 5,413,020; 6,215,052; 6,703,546; and D309,674. These designs do not lend themselves to easy transport in a pocket or wallet. Another device addresses the need for easy transport in a pocket or wallet, however, this device requires either two pieces of material to be bound to each other to hold the picks, or multiple slots to be cut in a flexible material to hold the picks. See U.S. Pat. No. 8,134,059. Providing a device which requires binding two pieces of material together is more complicated than a single-piece construction. Another prior art approach for providing a guitar pick holder comprises a recessed rim and a rear support plate. See U.S. Pat. No. 8,389,838. See also U.S. Pat. No. 9,018,502 which describes a guitar pick holder which may be incorporated into jewelry such as necklaces, earrings, keychains, skeleton claws or hinged clasps that open. And see U.S. Pat. No. D575,667 which illustrates a pendant with an insert to store an item in a slot.

None of the devices developed to date are completely satisfactory for storing, transporting and dispensing guitar picks and other substantially flat objects.

Thus there exists a need for a simple apparatus to store, transport and dispense picks that can be formed in a variety of shapes (e.g., from credit card shapes to jewelry shapes) and that is easy to manufacture, practical, thin, aesthetically pleasing and artful. Furthermore, there is a need for a simple apparatus which can be used to store, transport and dispense a variety of substantially flat objects other than guitar picks.

### SUMMARY OF THE INVENTION

The present invention relates to an apparatus for storing, transporting and dispensing objects, including but not limited to guitar picks, coins or other substantially flat objects. The apparatus comprises a holder having at least one recess formed therein for receiving and holding (and subsequently dispensing) the substantially flat object. The at least one recess can be, but need not be, shaped similarly to the object which is to be held. One or more tab(s) or ridge(s) are provided on the periphery of the recess so that the one or more tabs or ridges overhang the recess and secure an object in the recess to the holder. Further, the invention may or may not include a release feature in the floor of the recess to facilitate release of the object from the recess. The apparatus for storing, transporting and dispensing one or more objects can be provided in a variety of shapes including, but not limited to, a credit card shape for easy storage in a wallet, jewelry shapes, etc. Jewelry shapes can include, but are not limited to, keychains, necklaces, bracelets, earrings, rings, cufflinks, tie clips, pins, hairclips, watchbands and other jewelry shapes. Optionally, a clip or other attachment means may be integrated into the design to facilitate attaching the apparatus to a variety of items including, but not limited to, shirts, ties, guitar straps, guitars, guitar cases or other items. Materials used to form the holder include, but are not limited to, plastic, wood, plant, metal, cloth, man-made materials, animal skins or a combination of these materials.

In one preferred form of the invention, there is provided apparatus for storing, transporting and dispensing at least one substantially flat object, the apparatus comprising:

a holder comprising a front surface and a back surface;

at least one recess formed in the front surface of the holder, the at least one recess comprising a floor and an outer perimeter wall, and the at least one recess being sized to seat the substantially flat object therein; and

at least one tab mounted to the holder and extending out over the at least one recess, the at least one tab comprising a rear surface facing the floor of the at least one recess, the at least one tab being configured to hold the substantially flat object in the at least one recess.

In another preferred form of the invention, there is provided a method for storing, transporting and dispensing at least one substantially flat object, the method comprising:

providing apparatus comprising:
a holder comprising a front surface and a back surface;
at least one recess formed in the front surface of the holder, the at least one recess comprising a floor and an outer perimeter wall, and the at least one recess being sized to seat the substantially flat object therein; and
at least one tab mounted to the holder and extending out over the at least one recess, the at least one tab comprising a rear surface facing the floor of the at least one recess, the at least one tab being configured to hold the substantially flat object in the at least one recess;

positioning at least one substantially flat object in the at least one recess; and

dispensing at least one substantially flat object from the at least one recess.

### BENEFITS OF THE INVENTION

The present invention allows people to quickly and easily store, transport and dispense substantially flat objects such as, but not limited to, guitar picks. The benefits of this invention include but are not limited to:

(1) the combination of a recess and tab(s) or ridges(s) provide a very compact seat for guitar picks and other substantially flat objects, so that the holder can be, but is not required to be, barely larger and/or barely thicker than the object which is to be held;

(2) the easy storage of one or more substantially flat objects such as, but not limited to, guitar picks;

(3) the recesses can be arranged so as to fit a maximum number of objects on the holder;

(4) the ability of the holder to be credit card-shaped, thin, and store a plurality of objects for easy storage in a wallet or purse;

(5) the holder can easily slide into a wallet or purse because the guitar pick or substantially flat object fits in the recess and does not stand significantly proud of the holder;

(6) the apparatus for storing, transporting and dispensing the objects can be in the form of a variety of holder shapes including, but not limited to, credit card shapes, keychains, necklaces, bracelets, earrings, rings, cufflinks, pins, hairclips, watchbands or other jewelry shapes;

(7) it is easy to insert objects into the holder and remove objects from the holder;

(8) objects such as guitar picks are securely held in place so they do not fall out of the holder;

(9) the holder can secure picks of various thicknesses due to flexibility in the tabs or ridges;

(10) the easy release of the objects via several possible release features including, but not limited to, a hole in the back of the holder, a flexible tab on the back of the holder, a thinner membrane that is flexible, a soft area on the back made of fabric, rubber or some other flexible material, or a holder made of a flexible material;

(11) a single-piece construction may be used for easy manufacture by methods including, but not limited to, 3D printing, injection molding, or lost wax;

(12) a multi-layer construction may be used for easier manufacturing;

(13) multiple materials may be used on a single holder for improved functionality or aesthetic purposes;

(14) the holder can be made of a variety of materials including, but not limited to, plastic, wood, plant, metal, cloth, man-made materials, animal skins or a combination of these materials;

(15) holes can be added in the back of the holder under the tabs or ridges for easier manufacturing;

(16) a clip can be added to the holder to facilitate attaching the holder to flat items such as, but not limited to, guitar straps, belts, ties, pockets, etc.; and

(17) other means for attaching the holder to other items may be provided and include, but are not limited to, Velcro-type fasteners, pins, hooks or clasps.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1-8 are schematic views showing a novel holder formed in accordance with the present invention, wherein the novel holder is configured for storing, transporting and dispensing guitar picks and other substantially flat objects;

FIGS. 9 and 10 are schematic views showing the holder of FIGS. 1-8 storing guitar picks;

FIGS. 11-15 are schematic views showing another holder formed in accordance with the present invention;

FIG. 16 is a schematic view showing another holder formed in accordance with the present invention;

FIG. 17 is a schematic view showing another holder formed in accordance with the present invention;

FIG. 18 is a schematic view showing another holder formed in accordance with the present invention;

FIG. 19 is a schematic view showing another holder formed in accordance with the present invention;

FIG. 20 is a schematic view showing another holder formed in accordance with the present invention;

FIG. 21 is a schematic view showing another holder formed in accordance with the present invention;

FIG. 22 is a schematic view showing another holder formed in accordance with the present invention;

FIG. 23 is a schematic view showing another holder formed in accordance with the present invention; and

FIG. 24 is a schematic view showing another holder formed in accordance with the present invention.

### DETAILED DESCRIPTION OF THE PREFERRED EMBODIMENTS

The present invention provides an improved approach for storing, transporting and dispensing guitar picks and other substantially flat objects. This invention lends itself to, but is not limited to, a credit card shape, or jewelry shapes, etc.

As will hereinafter be discussed in further detail, the present invention comprises the provision and use of novel apparatus for storing, transporting and dispensing guitar picks and other substantially flat objects. The apparatus comprises a holder having at least one recess formed therein for holding an object to the holder. This recess can have a shape similar to the object which is to be held, although it need not have such a shape. One or more tabs or ridges, strategically placed about the perimeter of the recess to allow the object to easily slide into the recess, secure the object in the recess against accidental release. The object can subsequently be released from the recess upon the application of an appropriate force. The compact size of the recess and tabs or ridges allow for greater flexibility in the shape of the holder. An optional release feature can be provided in the floor of the recess so that the object can be pushed out of the recess, thereby allowing the object to be easily released from the holder.

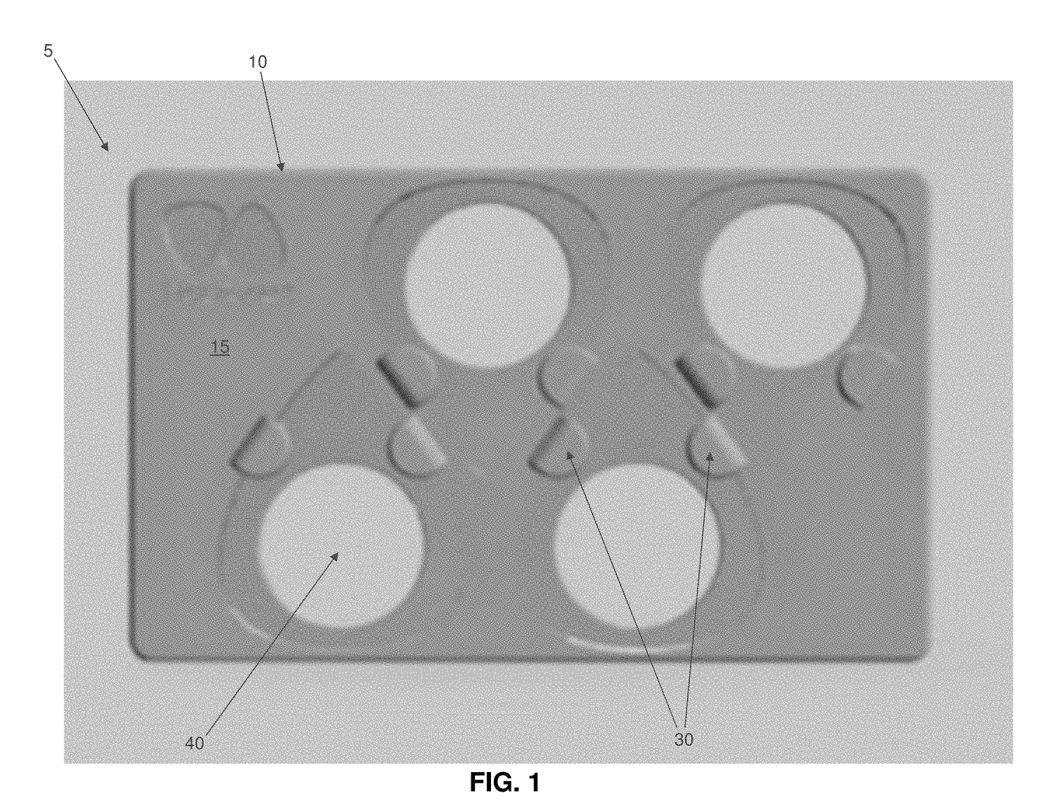

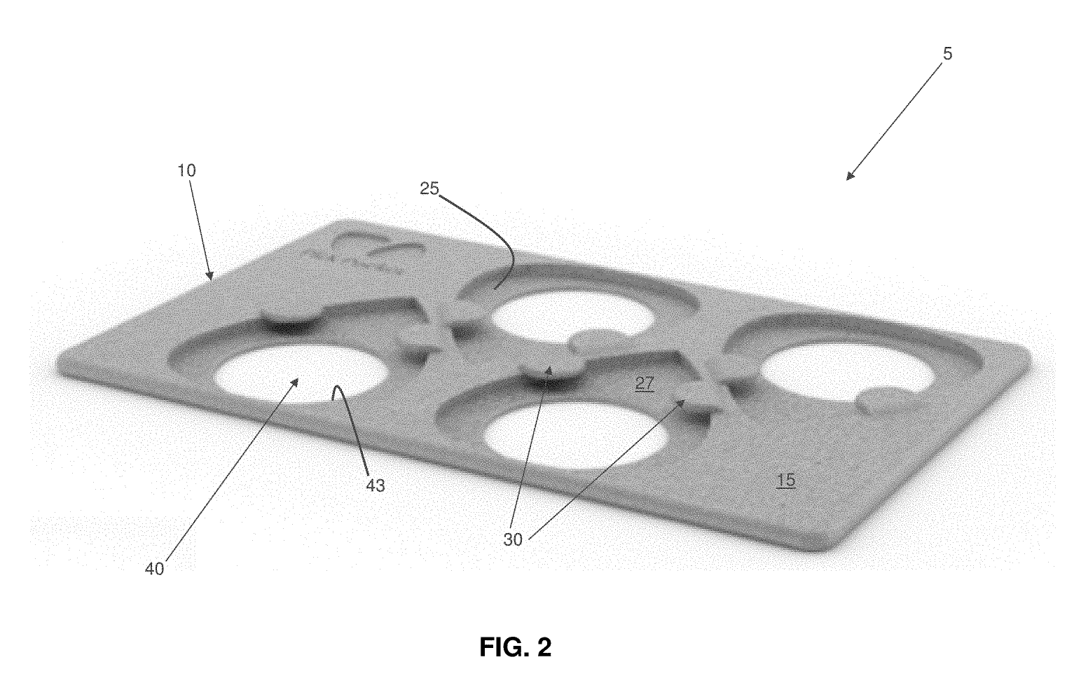

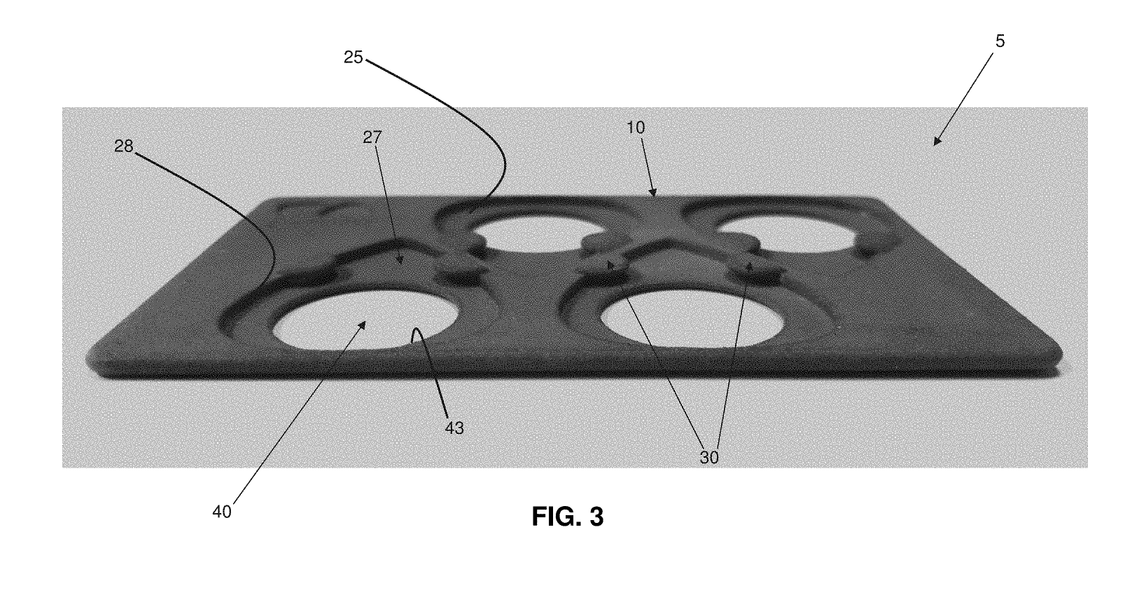

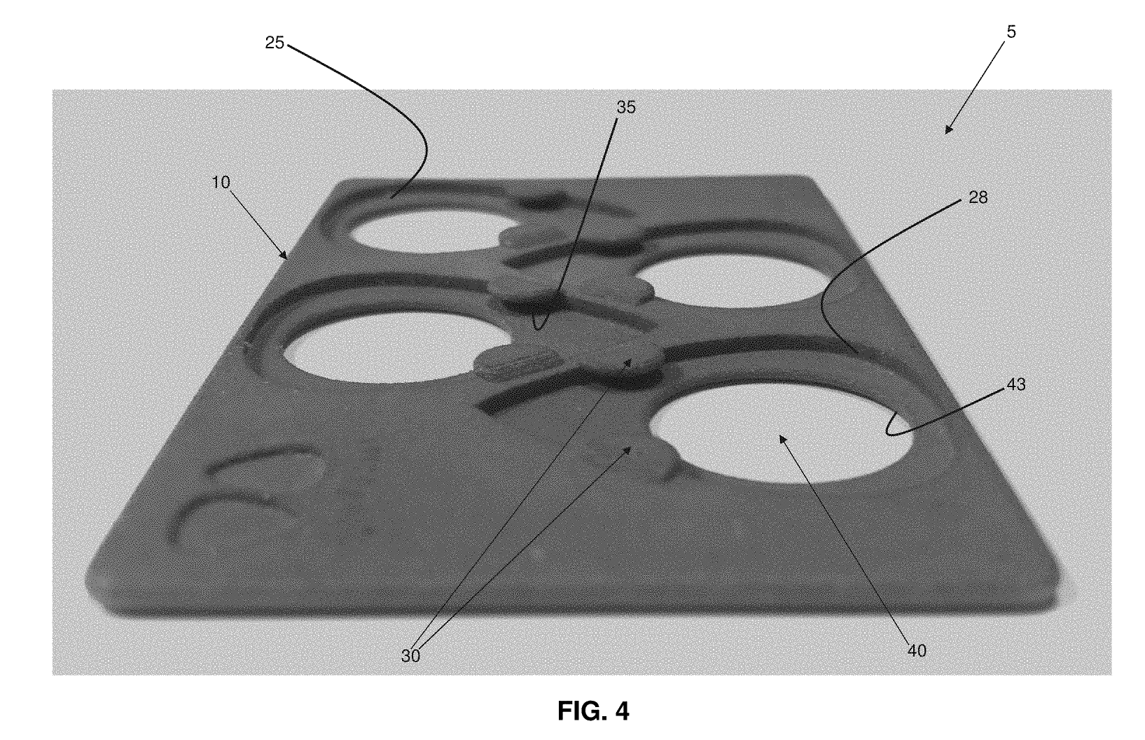

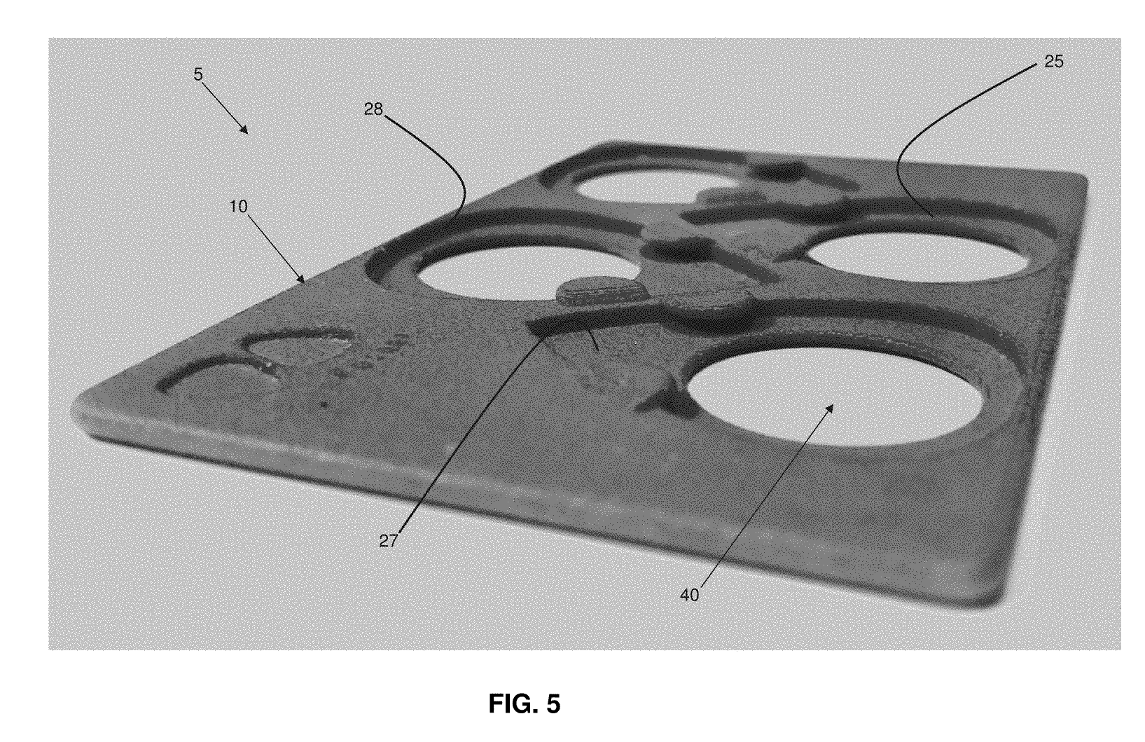

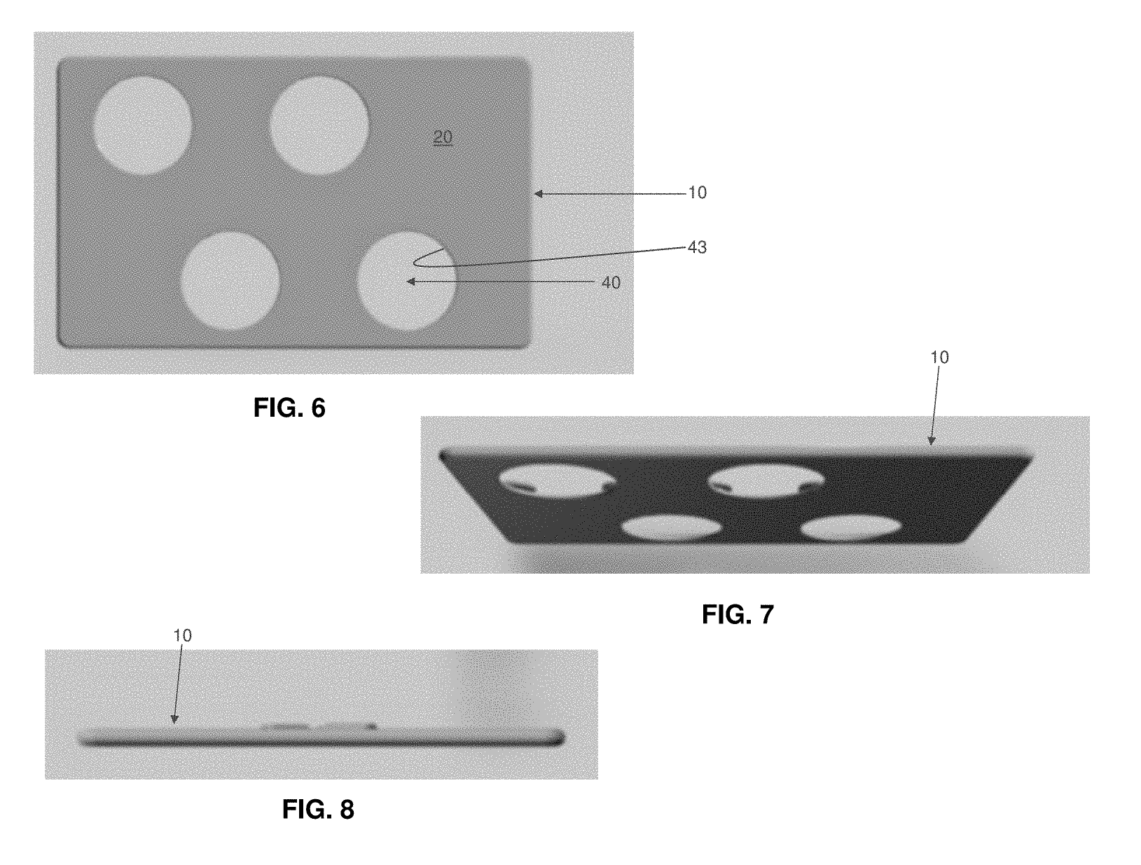

Looking first at FIGS. 1-8, there is shown apparatus 5 for storing, transporting and dispensing guitar picks and other substantially flat objects. Apparatus 5 comprises a holder 10 having a generally credit card-shaped configuration. Holder 10 is characterized by a front surface 15 and a back surface 20. In this form of the invention, holder 10 has a rectangular shape wherein the holder is preferably between about 2 to about 5 inches in height, preferably about 2 to about 10 inches in width and preferably between about 0.01 inches to about 0.5 inches or more in thickness.

Holder 10 comprises one or more recesses 25 formed in front surface 15 of holder 10. Recesses 25 are generally characterized by a floor 27 and an outer perimeter wall 28. Where more than one recess 25 is provided, the multiple recesses can be arrayed in a variety of patterns. In one form of the invention, recesses 25 are arrayed in a pattern which provides the largest possible number of recesses 25 on the holder (and hence stores the largest possible number of guitar picks and other substantially flat objects on the holder). Alternatively, recesses 25 may be arrayed in a pattern which provides a more artistic layout, or recesses 25 may be arrayed in a pattern which leaves room for a marketing presentation, etc.

Recesses 25 may have the same configuration as the guitar picks or other substantially flat objects being stored in the recesses. By way of example but not limitation, the credit card-shaped holder 10 shown in FIGS. 1-8 is designed to hold one or more guitar picks, and to this end recesses 25 have a shape similar to that of a guitar pick, so that recesses 25 can receive a guitar pick therein. In other words, outer perimeter wall 28 of recesses 25 have a shape which mirrors the outer perimeter of a guitar pick. Alternatively, holder 10 can be intended to store another type of object (e.g., a coin) and recesses 25 can have a shape similar to the object being stored (e.g., circular). Or recesses 25 can be provided with a more generic shape as long as the recesses can hold the desired objects in place. Note that where generically-shaped recesses are provided, different recesses can hold differently shaped objects to the holder.

The depth of recesses 25 need only be deep enough to hold an object in place. Therefore, the depth of recesses 25 can be anywhere from less than the thickness of the object to be held to more than the thickness of the object to be held. Note that guitar picks can vary in thickness and this approach for storing the picks can accommodate variations in pick thickness. Note also that, if desired, recesses 25 can be deep enough so that each recess 25 can receive a plurality of objects therein, e.g., with the objects being stacked one upon another within the recess.

To further aid in holding the picks or other substantially flat objects to holder 10, one or more tabs or ridges 30 may be disposed about the perimeter of each recess 25. These tabs or ridges 30 are characterized by an overhang extending out over at least a portion of recess 25 so that the tabs or ridges 30 overlap a guitar pick or other substantially flat object disposed in recess 25. More particularly, tabs or ridges 30 comprise a rear surface 35 which faces towards the floor 27 of recess 25. In one preferred form of the invention, front surface 15 of holder 10 extends substantially parallel to back surface 20 of holder 10, floor(s) 27 of recess(es) 25 extend substantially parallel to front surface 15 and back surface 20, and the rear surface(s) 35 of tab(s) or ridge(s) 30 extend substantially parallel to front surface 15, back surface 20 and floor(s) 27. However, it should be appreciated that rear surface(s) 35 of tab(s) or ridge(s) 30 do not need to extend parallel to front surface 15, back surface 20 or floor(s) 27, i.e., they may extend at an angle to front surface 15, back surface 20 or floor(s) 27.

In one form of the invention, tabs or ridges 30 are configured so that their rear surfaces 35 are substantially aligned with front surface 15 of holder 10. In another form of the invention, tabs or ridges 30 are configured so that their rear surfaces 35 sit below front surface 15 of holder 10. In still another form of the invention, tabs or ridges 30 are configured so that their rear surfaces 35 sit above front surface 15 of holder 10.

Tabs or ridges 30 are preferably designed to be as small as possible so as to allow as much of the object to be displayed as possible. Larger tabs or ridges 30 can be used if desired for increased security in holding an object in a recess. This can be helpful for heavier, thicker, or larger objects.

With the construction shown in FIGS. 1-8, two tabs or ridges 30 are provided for each recess 25, however, more or less tabs or ridges 30 may be provided for each recess. Thus it will be appreciated that an object may be secured in a recess 25 in a variety of ways including, but not limited to, one tab or ridge 30 along a larger portion of the periphery of a recess, one larger tab or ridge 30 going across the width of a recess, or a plurality of tabs placed along the periphery of a recess.

Note that tabs or ridges 30 may be substantially rigid or substantially flexible, as desired. In one preferred form of the invention, tabs or ridges 30 are sufficiently rigid to prevent accidental release of an object from a recess, but sufficiently flexible to enable objects of varying thicknesses to be stored in a recess.

Thus it will be seen that one or more recesses 25 are formed in holder 10, with each recess 25 sized to provide a seat for an object which is to be stored, and with one or more tabs or ridges 30 overhanging the recess so as to help hold an object in a recess. Recesses 25 may have a depth which is less than the thickness of the object to be held, equal to the thickness of the object to be held, or greater than the thickness of the object to be held. Recesses 25 may have a perimeter which matches the perimeter of the object to be held, or recesses 25 may have a perimeter different than the perimeter of the object which is to be held. One or more tabs or ridges 30 is provided for each recess 25. Each tab or ridge 30 has a rear surface 35 which faces towards floor 27 of recess 25. Rear surface 35 may be coplanar with front surface 15 of holder 10, or may be disposed “above” or “below” front surface 15 of holder 10.

In one preferred form of the invention, holder 10 has a credit card shape and comprises a plurality of recesses 25, wherein each of the recesses 25 has a perimeter which matches the perimeter of the object which is to be held, and wherein a plurality of tabs or ridges 30 are provided for each recess 25, and wherein rear surfaces 35 of tabs or ridges 30 are coplanar with front surface 15 of holder 10.

In use, when an object is to be stored in holder 10, the object is slid into a recess 25 of holder 10 so that the object is disposed under the tabs or ridges 30 for that recess, whereby to secure the object in that recess. When an object is to be dispensed from holder 10, the object is slid out of recess 25. To this end, it can be preferable to form tabs or ridges 30 along only a portion of recesses 25 to facilitate sliding the object into or out of recess 25. Furthermore, it can also be preferable to form holder 10 out of a flexible material, so that holder 10 can be flexed somewhat at the edge of the recess so as to facilitate sliding an object out of a recess.

In addition to the foregoing, and still looking now at FIGS. 1-8, an optional release feature 40 can be included in the holder to aid in the removal of an object from recesses 25. The release feature is located in the recess which holds an object. Release feature 40 may have many possible embodiments, but in one preferred form of the invention, release feature 40 comprises a hole 43 which extends from floor 27 of recesses 25 through to back surface 20 of holder 10. Where release feature 40 comprises a hole 43 extending from floor 27 of recesses 25 through to back surface 20 of holder 10, release feature 40 is visible on the back of the holder. Release feature 40 may or may not be visible on the back of holder 10 where the release feature comprises a different construction.

In use, where release feature 40 comprises a hole 43 extending from floor 27 of recess 25 to back surface 20 of holder 10, when an object stored in a recess 25 of holder 10 is to be released, the user pushes their finger into the rear side of hole 43 and pushes the object upward out of recess 25 of holder 10 so that the object can be slid away from tabs or ridges 30 and hence released from its seat in holder 10.

One advantage of this new approach for holding and releasing objects such as guitar picks is that the holder may be very thin, e.g., the holder can be barely thicker than the object it holds, particularly where tabs or ridges 30 are also of minimal height.

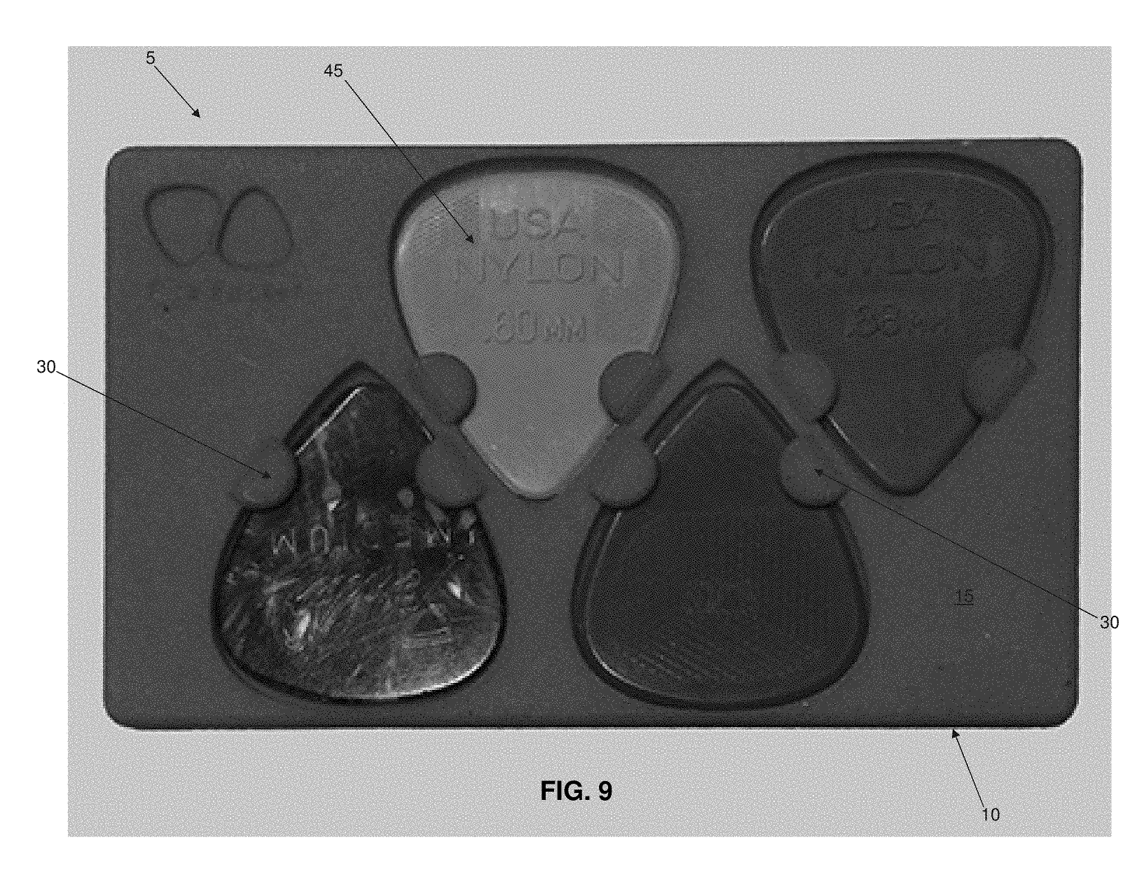

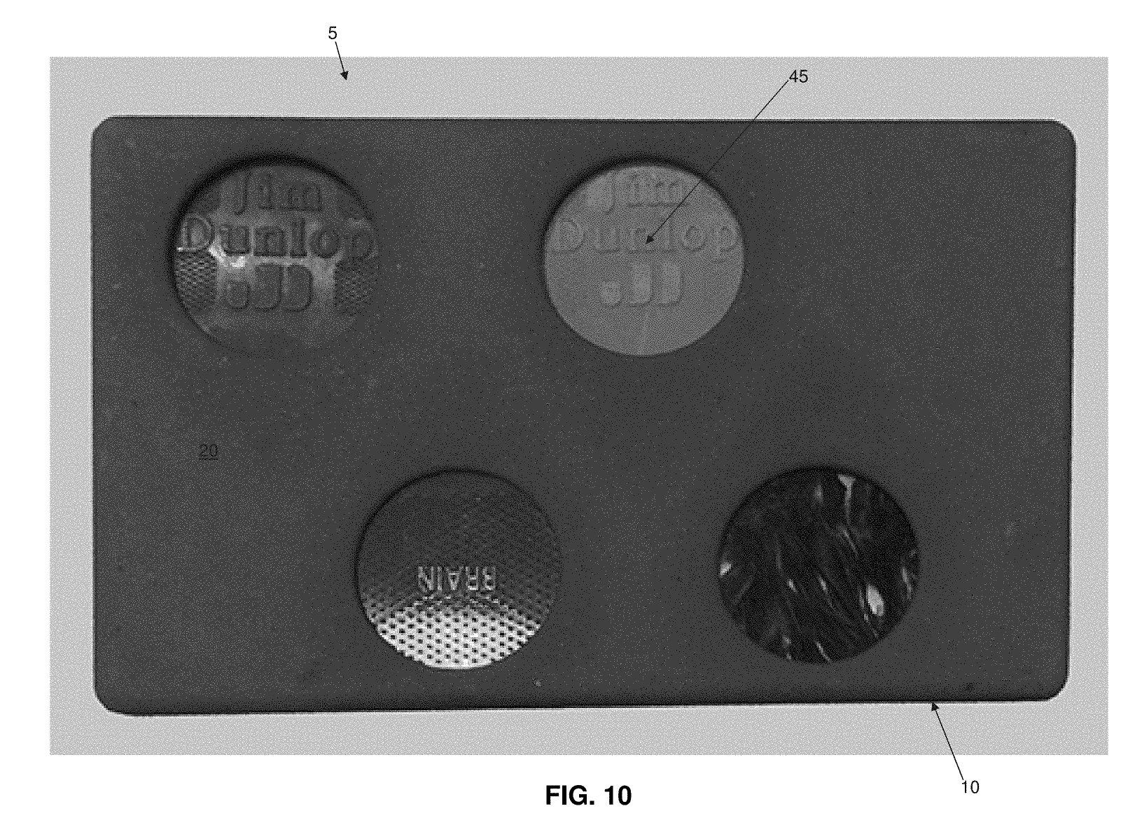

FIGS. 9 and 10 show guitar picks 45 in the recesses 25 of a holder 10, where holder 10 has the construction of FIGS. 1-8. FIGS. 9 and 10 show how the guitar pick can be placed securely in the recess and under the tabs of the holder. FIG. 10 shows how the guitar pick 45 can be seen on the back of the holder and how a hole 43 can be provided as a release feature to push the guitar pick above the edge of the recess in the holder.

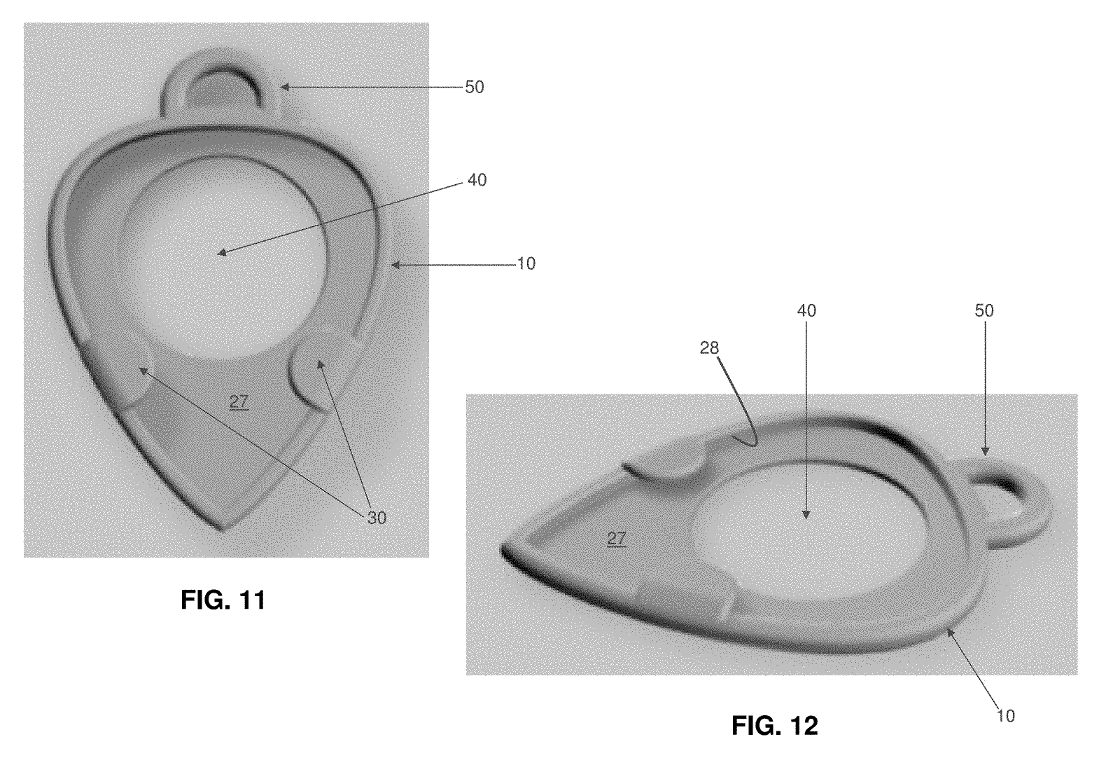

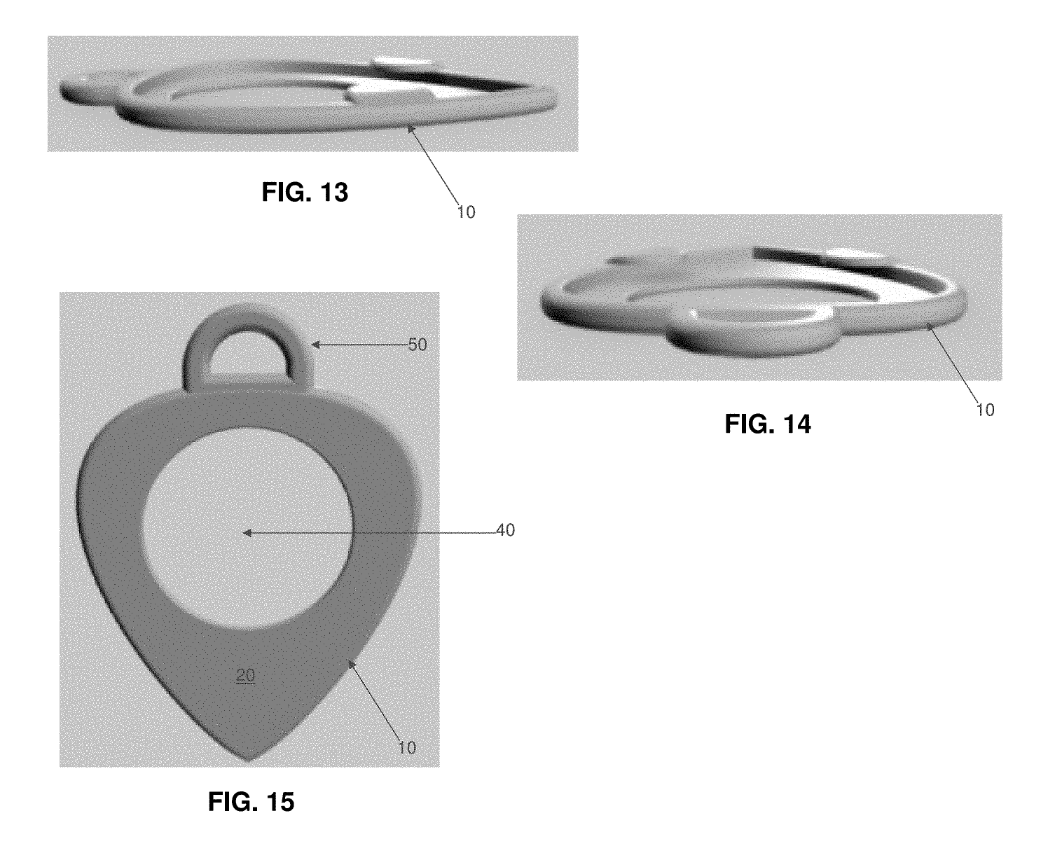

Holder 10 can be configured to hold a single object, in which case holder 10 can be formed barely larger than the object itself. See, for example, FIGS. 11-15 which illustrate how a holder 10 for a single object can be formed just slightly larger than the object which is to be held. In this form of the invention, it is common for holder 10 to have an outer perimeter which matches, or is highly similar to, the outer perimeter of the object which is to be held, although this need not necessarily be the case. Even with this minimal size, holder 10 preferably still has a recess 25, tabs or ridges 30, and release feature 40. Additionally, holder 10 can have an eyelet feature 50 for attaching the holder to other items including, but not limited to, a keychain, necklace, lanyard, tie clip, or earring stud (so that holder 10 can be used as an earring). As previously stated, recesses 25 can be shaped similarly to the object or have a more generic shape.

Note also that the holder 10 shown in FIGS. 1-10 may also be provided with an eyelet feature for attaching the holder to other items including, but not limited to, a keychain, necklace, lanyard, etc.

It should be noted that holder 10 may also be provided in a variety of shapes different from those presented in the embodiments of FIGS. 1-10 and FIGS. 11-15.

Although it is possible to release an object from holder 10 without a release feature 40, release feature 40 facilitates the easy release of an object from a recess 25. More particularly, the purpose of release feature 40 is to allow an object to be raised above the edge of a recess 25 (preferably on the side opposite from tabs or ridges 30) so that the object can be easily slid out of a recess 25. The release feature 40 shown in FIGS. 1-10, and the release feature 40 shown in FIGS. 11-15, is a hole 43. By pushing on the back of the object through hole 43, the object can be urged above the edge of the recess and slid out of the holder. Embodying release feature 40 in the form of a hole 43 provides the additional advantage that one can use the friction of actually touching the object to help slide the object out of the recess.

However, it should be appreciated that release feature 40 may comprise constructions other than a hole 43.

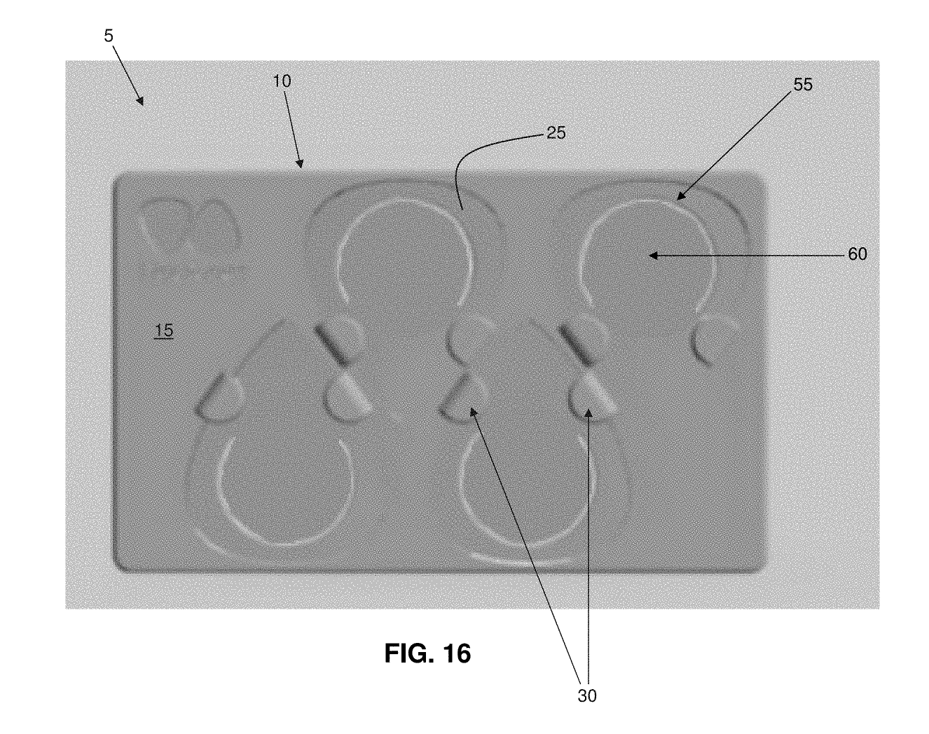

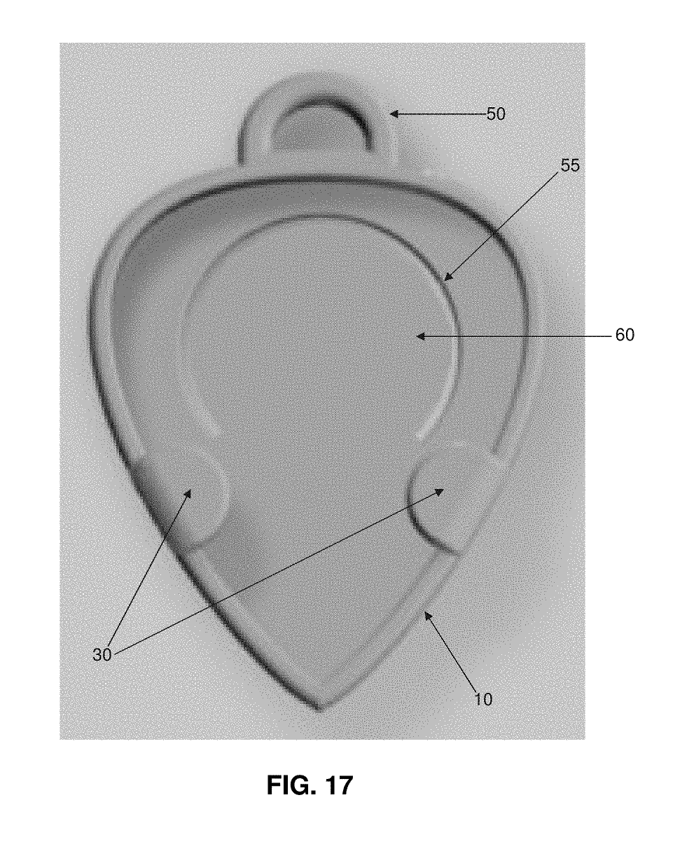

See, for example, FIGS. 16 and 17, where release feature 40 comprises a slot 55 (which may be semicircular or any other shape) in floor 27 of recess 25, whereby to create a flexible tab 60. Flexible tab 60 can be used to raise an object above the edge of a recess by pressing on the rear side of flexible tab 60. Preferably flexible tab 60 has a reasonable degree of structural integrity so that it will remain aligned with floor 27 of recess 25, and aligned with back surface 20 of holder 10, when flexible tab 60 is not being pressed forward by the finger of a user.

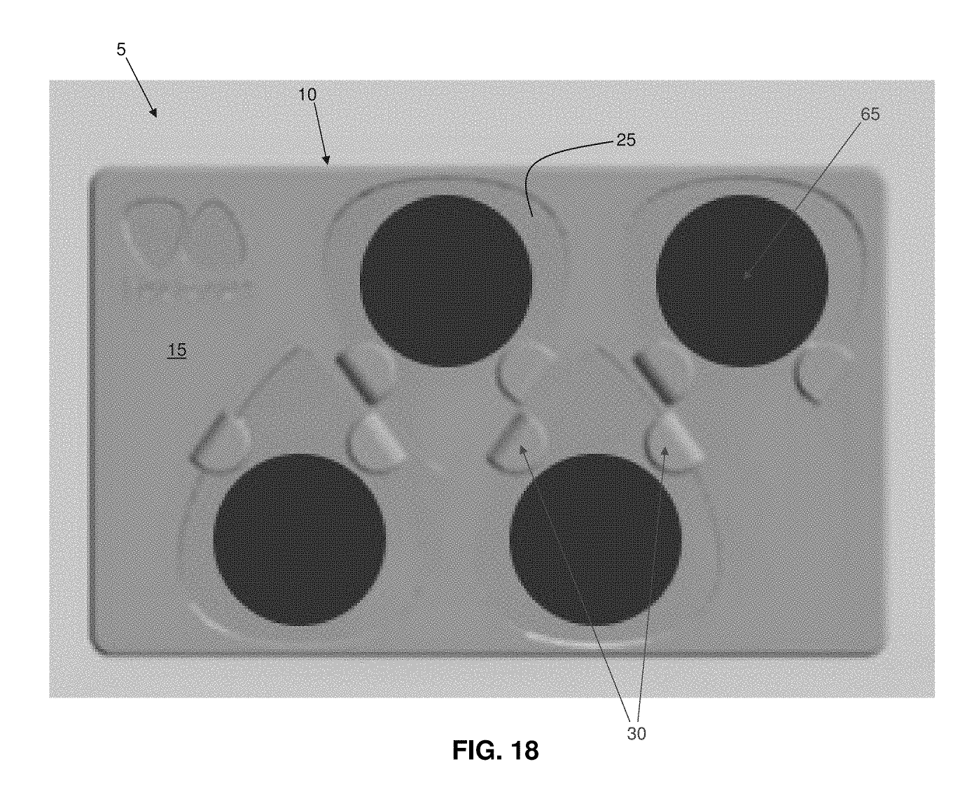

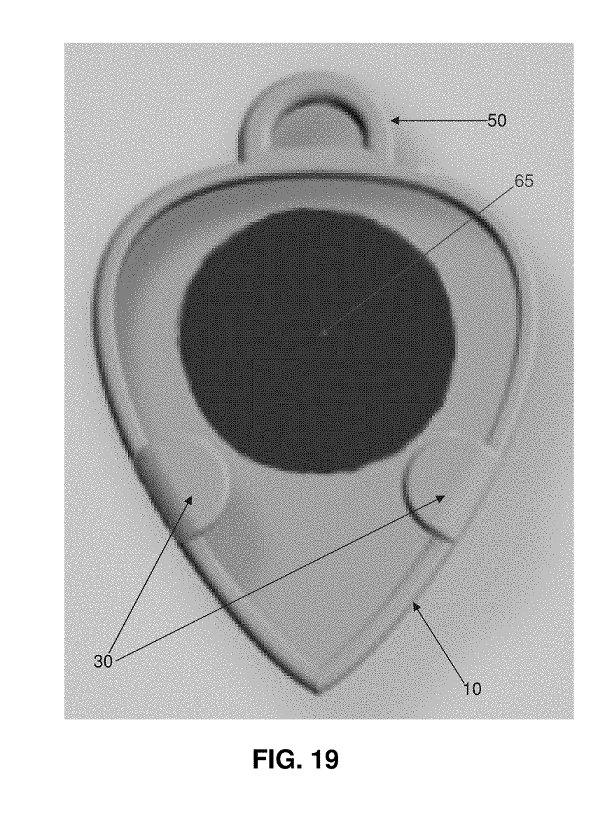

See also, for example, FIGS. 18 and 19, where release feature 40 comprises a flexible sheet 65 (e.g., of rubber, cloth, etc.) which may be used to raise the object above the edge of recess 25. In one form of the invention, a hole 43 is formed in floor 27 of recess 25, and flexible sheet 25 covers hole 43. In another form of the invention, the entire floor 27 of recess 25 is formed out of the flexible sheet 65.

In still another form of the invention, the floor 27 of recess 25 is formed integral with the remainder of holder 10, but floor 27 of recess 25 is configured so as to be thin enough to be sufficiently flexible so that floor 27 can be pressed against so as to raise the object above the edge of the recess.

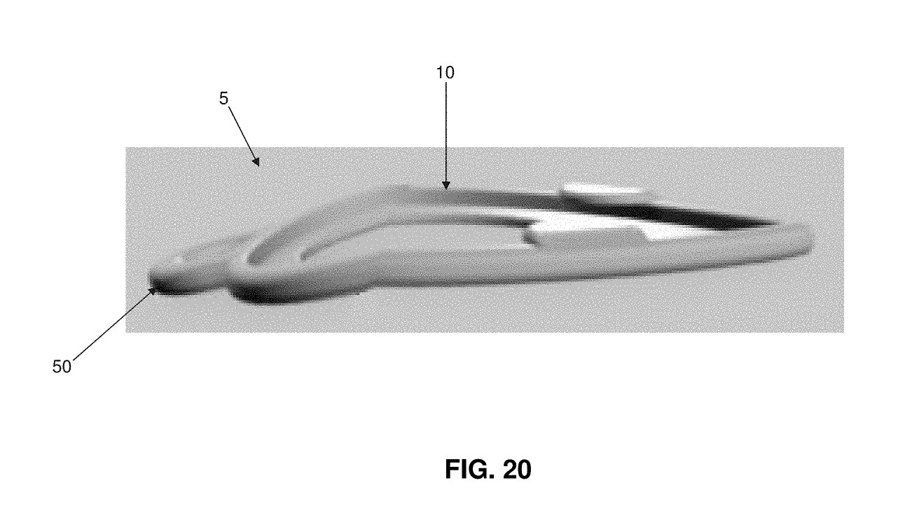

Another way to easily release an object from a recess 25 is shown in FIG. 20. More particularly, in this form of the invention, the body of holder 10 is formed out of a flexible material so that the body of the holder can be bent in such a way that the edge of the recess is moved out of the way of the object.

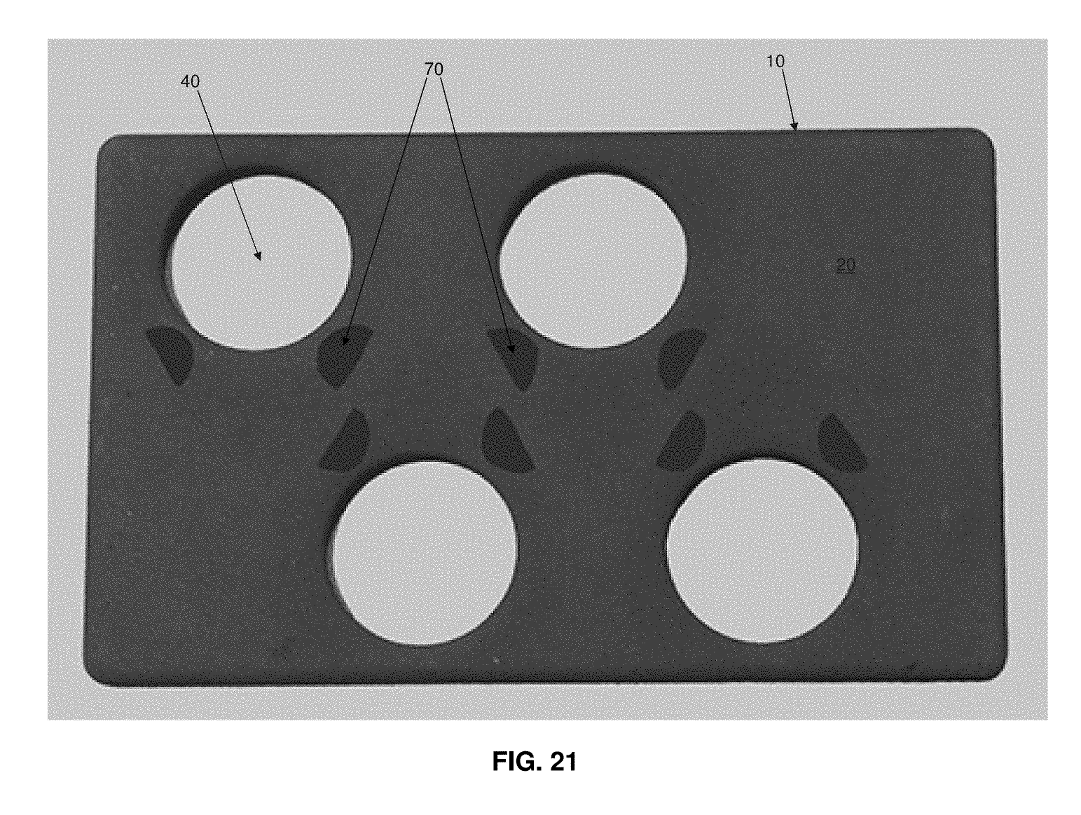

Another embodiment, shown in FIG. 21, illustrates how openings 70, shaped similarly to tabs or ridges 30, can be formed on the back of holder 10 in order to facilitate manufacturing of the holder using certain manufacturing techniques, such as but not limited to injection molding.

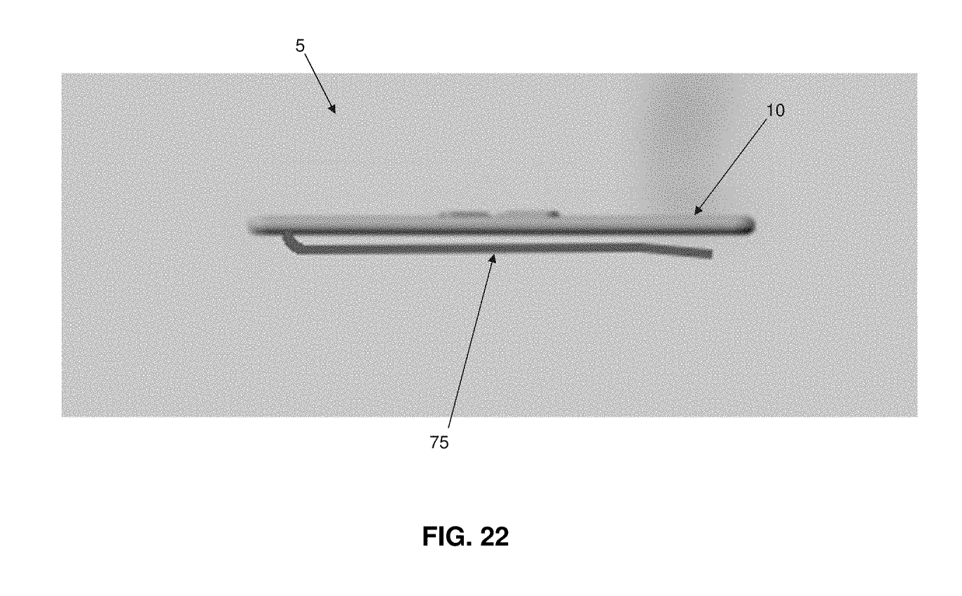

FIG. 22 illustrates how one or more clips 75 can be added to holder 10 to allow the holder to be clipped onto flat objects such as a guitar strap, guitar case, belt, waistband, shirt pocket, tie or other substantially flat object.

Other means of attaching holder 10 to other items include, but are not limited to, Velcro-type fasteners, pins, hooks or clasps.

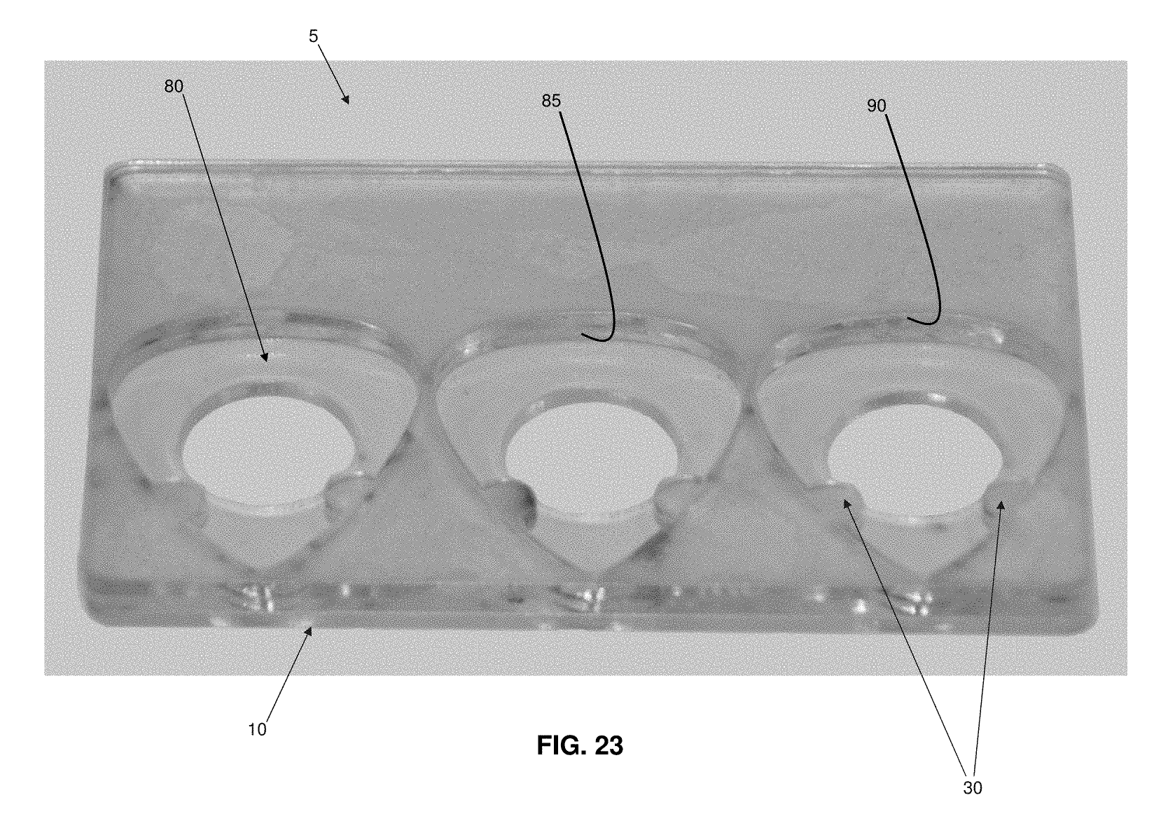

FIG. 23 illustrates a 3-layer construction for holder 10, wherein holder 10 comprises a back layer 80 having the release feature 40 (e.g., a hole 43), a middle layer 85 providing the perimeter wall 28 of recesses 25, and a top layer 90 having the tabs or ridges 30. Note that in this form of the invention, floors 27 of recesses 25 are provided by back layer 80.

In a 2-layer construction, back layer 80 and middle layer 85 may be combined into a single layer, and top layer 90 may be attached to that single layer, allowing for interchangeable tops to the holder.

Alternatively, middle layer 85 and top layer 90 may be combined into a single layer such that back layer 80 (providing floors 27 and release features 40) may be used with interchangeable top layers (formed by combining middle layer 85 and top layer 90), wherein the interchangeable top layers can have different configurations for recesses 25 and tabs or ridges 30.

With the multi-layer construction, the various layers can be secured to one another by a variety of means including, but not limited to, glue, solvent, epoxy, pins, rivets, snap fits, tabs, interference fits, tapes, screws, or other well known fastening means.

It should be appreciated that the multi-layer construction shown in FIG. 23, or the other multi-layer constructions discussed above, can be applied to any of the embodiments of the present invention.

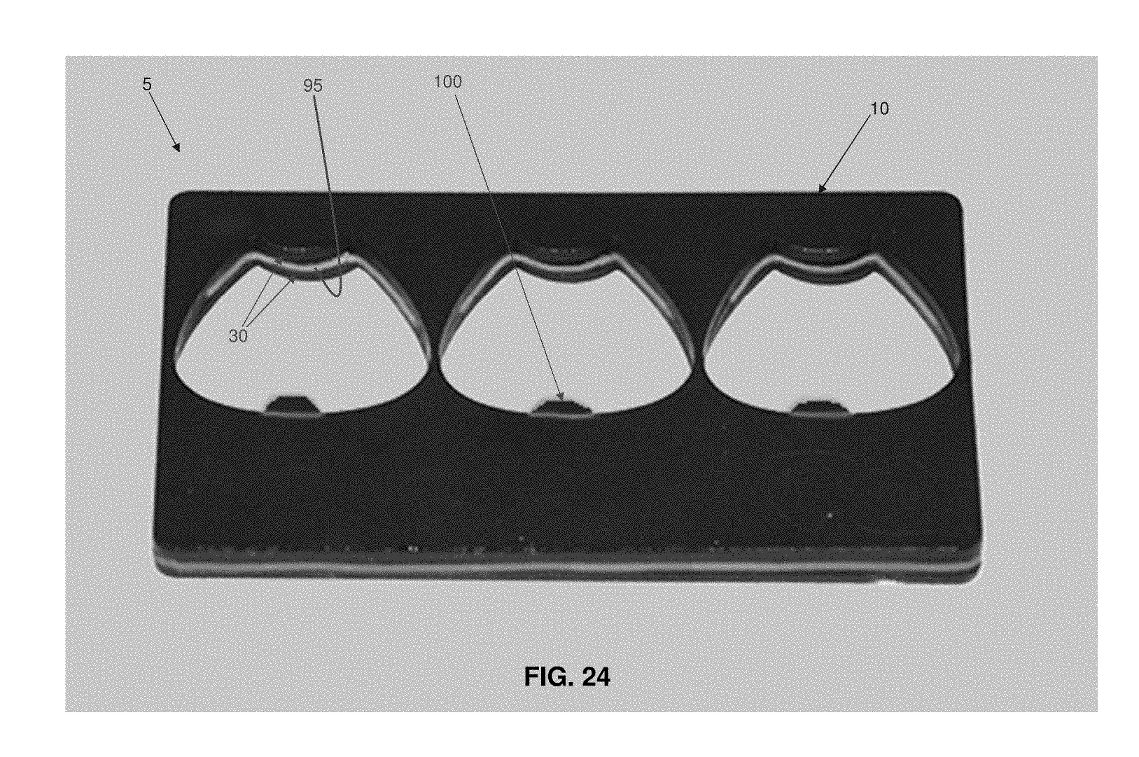

In another form of the invention, and looking now at FIG. 24, a pair of spaced tabs or ridges 30 are formed on one side of recess 25 so as to provide a gap 95, and a shelf 100 is formed on the other side of recess 25, with shelf 100 projecting into recess 25 so as to provide a shelf for supporting an object seated in recess 25. In this form of the invention, the rim of an object which is to be held is slipped into recess 25 so that the rim of the object is seated in gap 95 between two of the tabs or ridges 30, with the opposing side of the object seating on, and being supported by, shelf 100. It will be appreciated that in this form of the invention, shelf 100 essentially forms floor 27 of recess 25, and the open space defined between the outer perimeter wall 28 of recess 25 and the perimeter of shelf 100 essentially comprises release feature 40 (i.e., a non-circular hole).

### SOME SIGNIFICANT ASPECTS OF THE INVENTION

The present invention allows people to quickly and easily store, transport and dispense substantially flat objects such as, but not limited to, guitar picks. Significant aspects of this invention include but are not limited to:

(1) The present invention provides a holder which can store, transport and dispense guitar picks and a wide range of other substantially flat objects.

(2) A recess in the holder forms the foundation of an approach for holding the object. This recess can be shaped similarly to the object which is to be held, but is not limited to this configuration.

(3) One or more tabs or ridges, strategically placed on the edge of the recess, allow the object to easily slide into the recess while securing the object so it cannot accidentally come out of the recess.

(4) The compact size of the recess and tabs or ridges allow for greater flexibility in the design of the shape of the holder.

(5) An optional release feature can be placed in the recess so the object can be pushed up above the edge of the recess, allowing the object to easily slide out of the recess.

(6) The holder can be made in a variety of shapes including, but not limited to, a credit card shape for easy storage in a wallet, or jewelry shapes, etc. Jewelry shapes can include, but are not limited to, keychains, necklaces, bracelets, earrings, rings, cufflinks, tie clips, pins, hairclips, watchbands or other jewelry applications.

(7) Optionally, a clip or other attachment means may be integrated into the holder to attach the holder to a variety of items including, but not limited to, shirts, ties, guitar straps, guitars, guitar cases or other items.

(8) The holder may be formed out of materials which include, but are not limited to, plastic, wood, plant, metal, cloth, man-made materials, animal skins or a combination of these materials.

(9) The holder can be made of one or more layers of similar, or different, materials.

(10) Where the holders are made out of more than one layer, the layers can be connected by a variety of means including, but not limited to, glue, solvent, epoxy, pins, rivets, snap fits, tabs, interference fits, tapes, screws, or other common fastening means.

### MODIFICATIONS OF THE PREFERRED EMBODIMENTS

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. Apparatus for storing, transporting and dispensing at least one substantially flat object, the apparatus comprising:
a holder comprising a front surface and a back surface;
at least one recess formed in the front surface of the holder, the at least one recess comprising a floor and an outer perimeter wall, and the at least one recess being sized to seat the substantially flat object therein; and
at least one tab mounted to the holder and extending out over the at least one recess, the at least one tab comprising a rear surface facing the floor of the at least one recess, the at least one tab being configured to hold the substantially flat object in the at least one recess.

2. Apparatus according to claim 1 wherein the outer perimeter wall of the at least one recess has a shape similar to the perimeter of the substantially flat object.

3. Apparatus according to claim 1 wherein the outer perimeter wall of the at least one recess is generically shaped to hold a variety of different substantially flat objects.

4. Apparatus according to claim 1 wherein the substantially flat object comprises a guitar pick.

5. Apparatus according to claim 1 wherein the at least one tab is disposed on one side of the at least one recess so that the other side of the at least one recess can be used to slide a substantially flat object in and out of the at least one recess.

6. Apparatus according to claim 1 wherein the at least one tab covers a sufficiently small portion of the at least one recess so that a user can visually identify a substantially flat object stored in the at least one recess.

7. Apparatus according to claim 1 wherein the rear surface of the at least one tab is flush with the front surface of the holder.

8. Apparatus according to claim 1 wherein the at least one tab extends above the front surface of the holder.

9. Apparatus according to claim 1 wherein the at least one tab is disposed below the front surface of the holder.

10. Apparatus according to claim 1 further comprising a release feature for urging a substantially flat object out of the at least one recess. YOUNG-3

11. Apparatus according to claim 10 wherein the release feature is disposed in the at least one recess.

12. Apparatus according to claim 1 wherein the release feature comprises one from the group consisting of a hole formed in the floor of the at least one recess, a flexible tab formed in the floor of the at least one recess, flexible material disposed in the at least one recess, and the floor of the at least one recess being configured to be flexible.

13. Apparatus according to claim 1 wherein the holder is credit card-shaped.

14. Apparatus according to claim 13 wherein the holder is between about 2 to about 5 inches in height, about 2 to about 10 inches in width and between about 0.01 inches to about 0.5 inches or more in thickness.

15. Apparatus according to claim 13 wherein a plurality of recesses are formed in the holder.

16. Apparatus according to claim 1 wherein the holder is sized slightly larger than the substantially flat object and comprises an eyelet for securing the holder to another item.

17. Apparatus according to claim 1 wherein the holder is formed out of at least one material selected from the group consisting of plastic, wood, plant, metal, cloth, man-made materials, animal skins or a combination of these materials.

18. Apparatus according to claim 1 further comprising a clip mounted to the holder, wherein the clip is configured to enable the holder to be mounted to another item.

19. Apparatus according to claim 1 wherein the holder comprises a single layer.

20. Apparatus according to claim 1 wherein the holder comprises at least two layers.

21. Apparatus according to claim 20 wherein the at least two layers comprise a plurality of materials.

22. Apparatus according to claim 20 wherein the at least two layers are connected together by at least one from the group consisting of glue, solvent, epoxy, pins, rivets, snap fits, tabs, interference fits, tapes, screws, or other common fastening means.

23. A method for storing, transporting and dispensing at least one substantially flat object, the method comprising: providing apparatus comprising:
a holder comprising a front surface and a back surface;
at least one recess formed in the front surface of the holder, the at least one recess comprising a floor and an outer perimeter wall, and the at least one recess being sized to seat the substantially flat object therein; and
at least one tab mounted to the holder and extending out over the at least one recess, the at least one tab comprising a rear surface facing the floor of the at least one recess, the at least one tab being configured to hold the substantially flat object in the at least one recess;
positioning at least one substantially flat object in the at least one recess; and
dispensing at least one substantially flat object from the at least one recess.
